(19) United States
(12) Patent Application Publication
(10) Pub. No.: US 2009/0218503 A1
(43) Pub. Date: Sep. 3, 2009

(54) Semiconductor X-Ray Detector Device

(75) Inventors: Minoru Yamada, Kanagawa (JP); Masaru Simada, Kanagawa (JP)

Correspondence Address: JORDAN AND HAMBURG LLP, 122 EAST 42ND STREET, SUITE 4000, NEW YORK, NY, 10168, US

(73) Assignee: SHIMADZU CORPORATION, Kyoto-shi (JP)

(21) Appl. No.: 12/226,838

(22) PCT Filed: May 29, 2007
(86) PCT No.: PCT/JP2007/000570

§ 371 Date: Oct. 29, 2008

(30) Foreign Application Priority Data
May 31, 2006 (JP) 2006-150766

(51) Int. Cl. G01T 1/24

(52) U.S. Cl. 250/370.14

(57) ABSTRACT

A semiconductor X-ray detector device has an i layer configured to substantially a circular cylindrical shape but not a conventional top-hat shape and a p layer provided to substantially cover the circumferential side of the i layer. Both an n+ layer and an n surface electrode are arranged smaller in the area than the bottom at the n surface electrode side of the i layer in order to expose the i layer entirely to the electric field E. Accordingly, the spectrum remains not fractured in the profile when the n+ layer and the n surface electrode are not greater in the area than 33% of the bottom at the n surface electrode side of the i layer, hence permitting the resolving power to stay high.

### FIELD OF THE INVENTION

The present invention relates to a semiconductor X-ray detector device and more particularly to a semiconductor X-ray detector device which has high resolution.

### BACKGROUND OF THE INVENTION

It has been known for a top-hat type of semiconductor X-ray detector device 50, as shown in FIG. 13, to have the n+ layer 2 and the n surface electrode 3 arranged smaller in area than the bottom at the n surface electrode side of the i layer 1 (See, for example, Patent Citation 1).

Patent Citation 1; Japanese Patent Laid-open Publication No. 2005-183603.

### SUMMARY OF THE INVENTION

The above described conventional semiconductor X-ray detector device 50 is modified in which the n+ layer 2 and the n surface electrode 3 are smaller in area than the bottom at the n surface electrode side of the i layer 1 so that the resolution becomes higher than that of any conventional top-hat type semiconductor X-ray detector device (where the n+ layer 2 and the n surface electrode 3 are equal in area to the bottom at the n surface electrode side of the i layer 1).

However, when the n+ layer 2 and the n surface electrode 3 are not greater in area than 33% of the bottom at the n surface electrode side of the i layer 1, a drawback will arise in that the spectrum significantly exhibits an unfavorable profile such as a tail towards the lower energy side. In other words, there is a limit for decreasing the area of each of the n+ layer 2 and the n surface electrode 3 to a size smaller than the area of the bottom at the n surface electrode side of the i layer 1, whereby resolution will hardly be enhanced beyond the limit.

It is hence an object of the present invention to provide a semiconductor X-ray detector device which can have a higher resolution.

### BRIEF DESCRIPTION OF THE DRAWINGS

FIG. 1 is a cross sectional view of a semiconductor X-ray detector device showing Embodiment 1 of the present invention;

FIG. 2 is resolution/temperature characteristic diagram of MnKα on the semiconductor X-ray detector device of Embodiment 1;

FIG. 3 is a flowchart showing the steps of manufacturing the semiconductor X-ray detector device of Embodiment 1;

FIG. 4 is an explanatory view showing the step of vapor deposition of Li;

FIG. 5 is an explanatory view showing the step of thermal diffusion of Li;

FIG. 6 is an explanatory view showing the step of developing the n surface electrode;

FIG. 7 is an explanatory view showing the step of providing the annular groove;

FIG. 8 is an explanatory view showing the step of drifting of Li;

FIG. 9 is an explanatory view showing the step of developing the i layer and the p layer;

FIG. 10 is an explanatory view showing the step of developing the p surface electrode (Au);

FIG. 11 is an explanatory view showing the step of providing the entrance window;

FIG. 12 is an explanatory view showing the step of developing the p surface electrode (Ni);

FIG. 13 is a cross sectional view of a conventional semiconductor X-ray detector device; and

FIG. 14 is a resolution/temperature characteristic diagram of MnKα on the conventional semiconductor X-ray detector device.

### DESCRIPTION OF THE PREFERRED EMBODIMENTS

As a first feature of the present invention, a semiconductor X-ray detector device (10) is provided comprising: an i layer (1) of substantially a circular cylindrical shape; an n+ layer (2) and an n surface electrode (3) disposed on the bottom at the center of the n surface electrode side of the i layer (1); a p surface electrode (7) disposed to cover the bottom at the p surface electrode side of the i layer (1); and a p layer (5) disposed to substantially cover the circumferential side of the i layer (1).

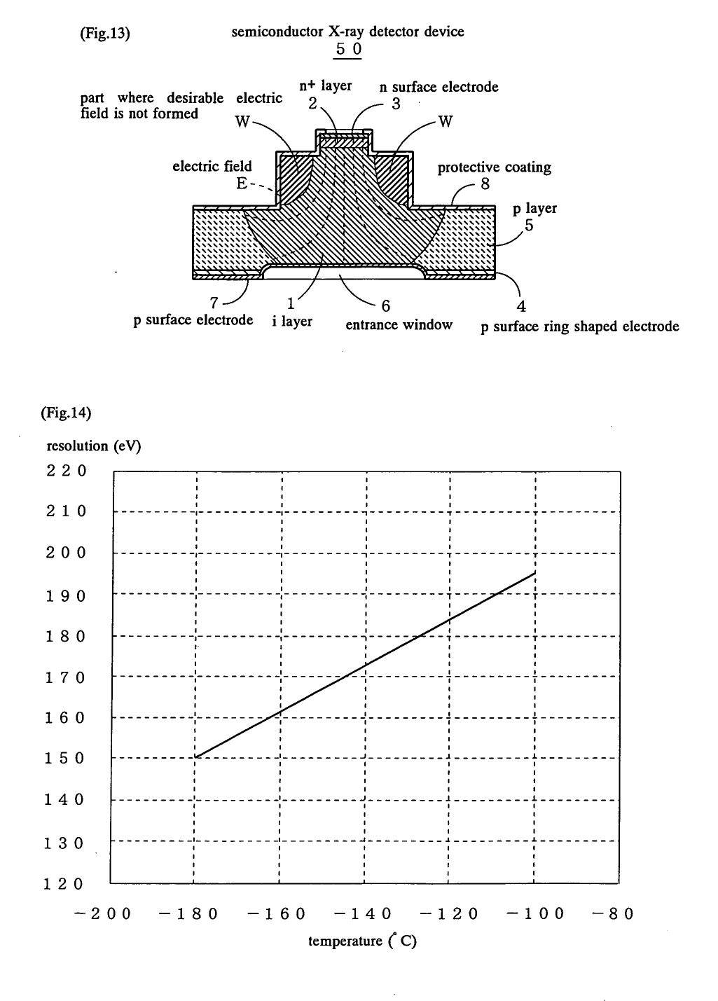

It is supposed that the reason why the conventional semiconductor X-ray detector device 50 has the foregoing drawback depends largely on the fact that when the n+ layer 2 and the n surface electrode 3 are arranged smaller in the area than the bottom at the n surface electrode side of the i layer 1, the region W which is hardly exposed to the electric field as shown in FIG. 13 becomes large.

The semiconductor X-ray detector device (10) of the first feature allows the i layer (1) to be configured to not a known top-hat shape but substantially a circular cylindrical shape and almost entirely covered at the circumferential side by the p layer (5). Accordingly, as shown in FIG. 1, the i layer (1) is exposed entirely to the electric field E even when the n+ layer (2) and the n surface electrode (3) are disposed on the bottom at the center at the n surface electrode side of the i layer (1) (i.e., the n+ layer (2) and the n surface electrode (3) are arranged smaller in area than the bottom at the n surface electrode side of the i layer (1)). More particularly, even when the n+ layer (2) and the n surface electrode (3) are not greater in area than 33% of the bottom at the n surface electrode side of the i layer (1), resolution can be higher while the foregoing drawback does not arise.

The term “substantially a circular cylindrical shape” means a circular cylindrical shape of which the circumferential side expands outwardly. The terms “to substantially cover the circumferential side of the i layer (1)” means that the circumferential side of the i layer (1) has a small region thereof, just beneath the n+ layer (2), not covered with the p layer (5). The area of the small regions of the circumferential side of the i layer (1) not covered with the p layer (5) is not greater than 3% of the entire area of the circumferential side of the i layer (1).

As a second feature of the present invention, the semiconductor X-ray detector device (10) of the first feature may be modified in which the bottom at the p surface electrode side of the i layer (1) is not smaller than 20 square millimeters in area while each of the n+ layer (2) and the n surface electrode (3) is not greater than 6.6 square millimeters in area.

The semiconductor X-ray detector device (10) of the second feature allows both the n+ layer (2) and the n surface electrode (3) to be not greater in area than 33% of the bottom at the n surface electrode side of the i layer (1), thus becoming higher resolution.

The semiconductor X-ray detector device (10) according to the present invention can hence have higher resolution than any conventional one.

The present invention will be described in more detail in conjunction of embodiments illustrated in the relevant drawings.

### Embodiment 1

FIG. 1 is a cross sectional view of a semiconductor X-ray detector device 10 according to Embodiment 1 of the present invention.

The semiconductor X-ray detector device 10 comprises an i layer 1 of a substantially circular cylindrical shape; an n+ layer 2 and an n surface electrode 3 both disposed on the bottom at the center of the n surface electrode side of the i layer 1; a p surface electrode 7 disposed to cover the bottom at the p surface electrode side of the i layer 1; and a p layer 5 disposed to substantially cover the circumferential side of the i layer 1. Denoted by 4 is a p surface ring shaped electrode, 6 is an entrance window, and 8 is a protective coating.

As explained in the figures, the area of the bottom at the p surface electrode side of the i layer 1 is 20 square millimeters and the area of each of the n+ layer 2 and n surface electrode 3 is 3 square millimeters.

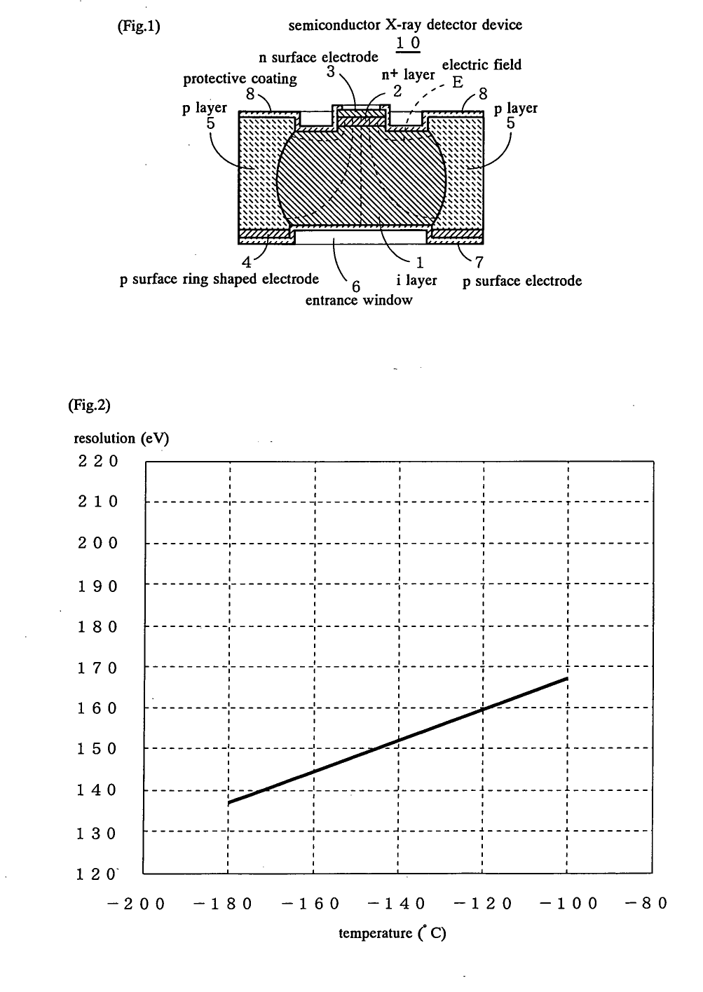

FIG. 2 is a resolution/temperature characteristic diagram of MnKα (Kα ray from manganese) on the semiconductor X-ray detector device 10 of which the bottom at the p surface electrode side of the i layer 1 is sized to 20 square millimeters and the n+ layer 2 and n surface electrode 3 are sized to 3 square millimeters. Meanwhile, the shaping time is 3 μs.

Similarly, FIG. 14 is a resolution/temperature characteristic diagram of MnKα on the semiconductor X-ray detector device 50 of which the bottom at the p surface electrode side of the i layer 1 is sized to 20 square millimeters and the n+ layer 2 and n surface electrode 3 are sized to 10 square millimeters.

It is apparent from the comparison between the two diagrams that semiconductor X-ray detector device 10 according to the present invention is higher resolution.

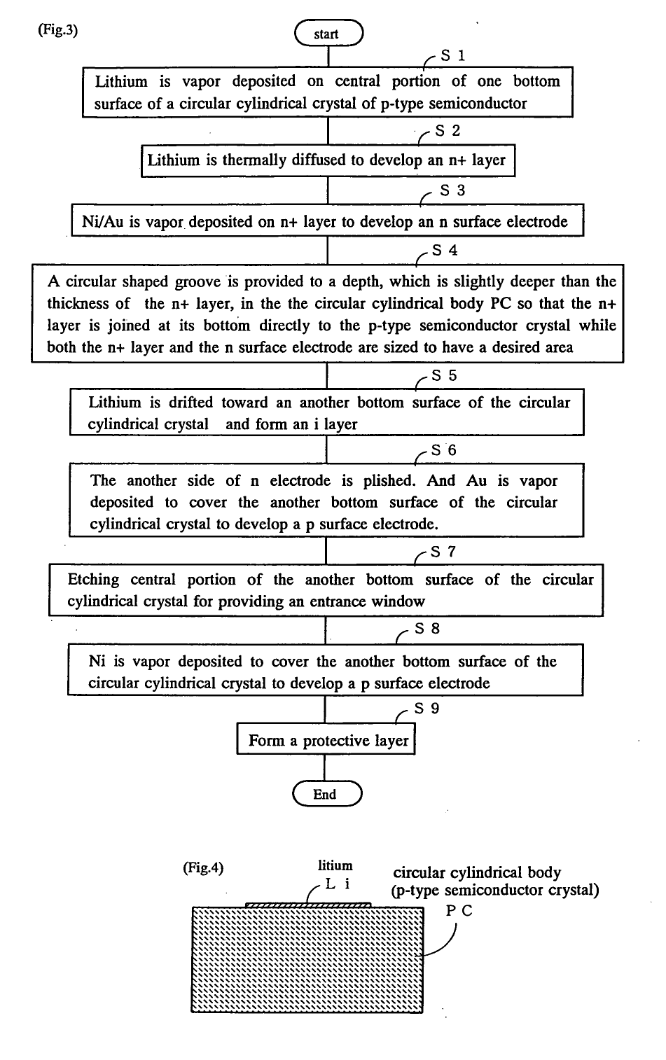

FIG. 3 is a flowchart showing steps of manufacturing the semiconductor X-ray detector device 10 of Embodiment 1.

At Step S1, as shown in FIG. 4, Li is vapor deposited on an upper surface of a circular cylindrical body PC of p-type semiconductor crystal. The p-type semiconductor crystal may be fabricated by shaping a p-type Si wafer into device (tablet) forms and mirror polished on both sides of each tablet.

At Step S2, as shown in FIG. 5, Li is thermally diffused to develop an n+ layer 2a and its residual is removed.

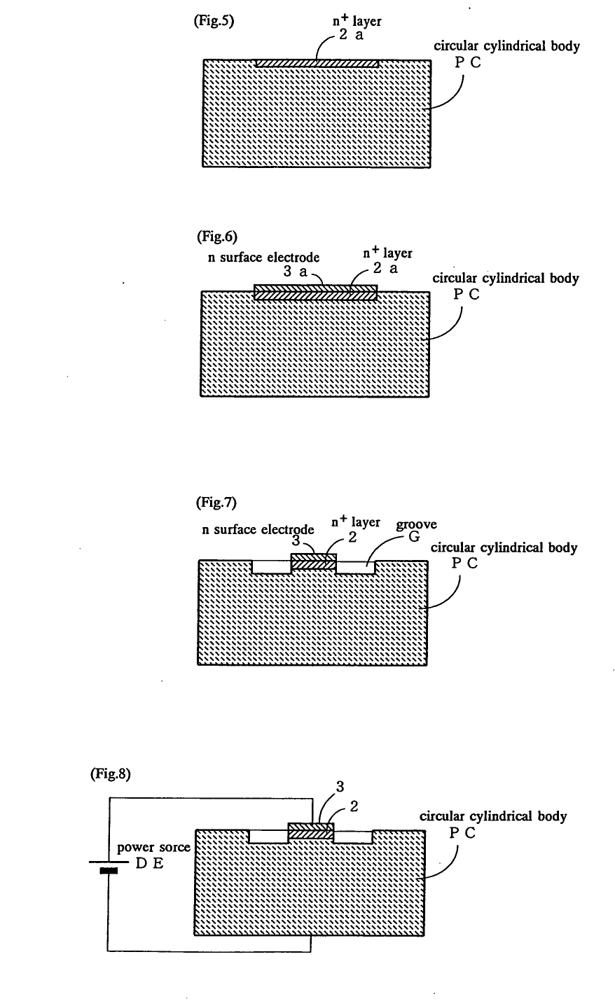

At Step S3, as shown in FIG. 6, Ni/Au is vapor deposited to develop an n surface electrode 3a.

At Step S4, as shown in FIG. 7, a groove is provided to a depth, which is slightly deeper than the thickness of the n+ layer 2, in the upper end of the circular cylindrical body PC so that the n+ layer 2 is joined at its bottom directly to the p-type semiconductor crystal while both the n+ layer 2 and the n surface electrode 3 are sized to have a desired area.

At Step S5, the entire arrangement is exposed to an electric field with the use of a power source DE while remaining heated as shown in FIG. 8 until Li is drifted to develop an i layer 1 of substantially a circular cylindrical shape as shown in FIG. 9. A donut shape of p layer 5 is thus developed on the circumferential side of the substantially cylindrical i layer 1.

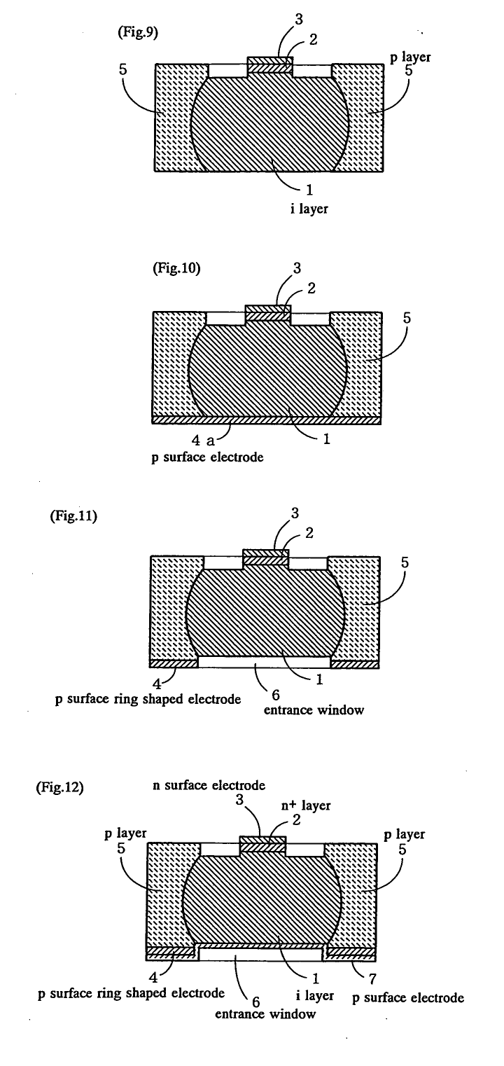

At Step S6, both the i layer 1 and the p layer 5 are polished at the bottom so that the area of the i layer 1 is a desired size and Au is vapor deposited on the bottom to develop a p surface electrode 4a as shown in FIG. 10.

At Step S7, as shown in FIG. 11, the arrangement is subjected to, for example, etching for providing an entrance window 6. This causes the p surface electrode 4a to turn to a p surface ring electrode 4.

At Step S8, as shown in FIG. 12, Ni is vapor deposited on the bottom to develop a p surface electrode 7.

At Step S9, as shown in FIG. 1, the arrangement is coated with, for example, a silicone resin material to develop a protective coating 8.

Since the semiconductor X-ray detector device 10 of Embodiment 1 has the i layer 1 configured to substantially a circular cylindrical shape but not a conventional top-hat shape and simultaneously surrounded by the p layer 5 and thus allows the i layer 1 to be exposed entirely to the electric field E even when the n+ layer 2 and the n surface electrode 3 are smaller in the area than the bottom at the n surface electrode side of the i layer 1. Accordingly, the spectrum remains not fractured in profile when the n+ layer 2 and the n surface electrode 3 are not greater in area than 33% of the bottom at the n surface electrode side of the i layer 1, hence permitting the resolving power to stay high.

### Embodiment 2

The p-type semiconductor crystal is replaced by a highly pure, highly resistive Si crystal circular cylindrical body. At Step S5 shown in FIG. 3, Li is not drifted but boron is diffused from the circumferential surface of the circular cylindrical body to develop a donut shape of p layer 5, whereby the i layer 1 of a circular cylindrical shape is provided as surrounded by the p layer 5.

The semiconductor X-ray detector device according to the present invention can be utilized as a detector in an energy dispersion type X-ray analyzing apparatus.

### Description of Numerals

1: i layer, 2: n+ layer, 3: n surface electrode, 4: p surface ring shaped electrode, 5: p layer, 7: p surface electrode, 10: semiconductor X-ray detector device.

1. A semiconductor X-ray detector device comprising an i layer of substantially a circular cylindrical shape; an n+ layer and an n surface electrode disposed on the bottom at the center of the n surface electrode side of the i layer; a p surface electrode disposed to cover the bottom at the p surface electrode side of the i layer; and a p layer disposed to substantially cover the circumferential side of the i layer.

2. A semiconductor X-ray detector device according to claim 1, wherein the bottom at the p surface electrode side of the i layer is not smaller than 20 square millimeters in the area while each of the n+ layer and the n surface electrode is not greater than 6.6 square millimeters in the area.
